(19) United States
(12) Patent Application Publication
(10) Pub. No.: US 2025/0264612 A1
(43) Pub. Date: Aug. 21, 2025

(54) Track Based Moving Object Association for Distributed Sensing Applications

(71) Applicants: Nissan North America, Inc., Franklin, TN (US); United States of America as Represented by the Administrator of NASA, Washington, DC (US)

(72) Inventors: Liam Pedersen, San Francisco, CA (US); Ritchie Lee, Sunnyvale, CA (US); Michael Nicholas Dille, Pittsburgh, PA (US); Vaishali Hosagrahara, Campbell, CA (US); Viju James, Fremont, CA (US); Christopher Ostafew, Mountain View, CA (US)

(21) Appl. No.: 18/582,838

(22) Filed: Feb. 21, 2024

(51) Int. Cl. G01S 17/66; G01S 17/58; G01S 17/86; G01S 17/931

(52) U.S. Cl. CPC G01S 17/66; G01S 17/58; G01S 17/86; G01S 17/931

(57) ABSTRACT

A track based moving object association is described for distributed sensing applications, such as for identifying multiple objects within a vehicle transportation network for use by a vehicle navigating the network. Position information for the multiple objects within a portion of the vehicle transportation network is obtained from multiple sensors within the portion of the vehicle transportation network. Using the position information of respective sensors of the multiple sensors, a respective track for objects of the multiple objects is determined. Similarity measures are determined for multiple tracks, including at least a first track determined using the position information of a first sensor of the multiple sensors and a second track determined using the position information of a second sensor of the multiple sensors. Based on the similarity measures of the tracks, a tracked object track for a tracked object of the multiple objects is determined.

### TECHNICAL FIELD

This application relates to a track based moving object association for distributed sensing applications, particularly for vehicle control applications.

### BACKGROUND

Transportation network data from and related to the transportation network and users of and proximate to the transportation network is available from sensors on vehicles traversing the transportation network and from infrastructure sensors proximate to the transportation networks. For example, the transportation network data can be received or obtained from fixed infrastructure, such as traffic cameras and inductive-loop traffic sensors, self-reported locations, and state information from connected road users and connected vehicle-mounted sensors. Processing the collected transportation network data to provide meaningful insights into the behavior of road users is difficult.

### SUMMARY

Disclosed herein are aspects, features, elements, and implementations for track based moving object association for distributed sensing applications.

An aspect of the disclosed implementations is an apparatus including a processor. The processor is configured to receive position information for multiple objects within a portion of a vehicle transportation network, the position information obtained from multiple sensors within the portion of the vehicle transportation network, determine, using the position information of a respective sensors of the multiple sensors, a respective track for objects of the multiple objects, determine respective similarity measures for multiple tracks, wherein the multiple tracks comprise at least a first track determined using the position information of a first sensor of the multiple sensors and a second track determined using the position information of a second sensor of the multiple sensors, and determine, based on the similarity measures, a tracked object track for a tracked object of the multiple objects.

Another aspect of the disclosed implementations is a method that includes receiving position information for multiple objects within a portion of a vehicle transportation network, the position information obtained from multiple sensors within the portion of the vehicle transportation network, determining, using the position information of a respective sensors of the multiple sensors, a respective track for objects of the multiple objects, determining respective similarity measures for multiple tracks, wherein the multiple tracks comprise at least a first track determined using the position information of a first sensor of the multiple sensors and a second track determined using the position information of a second sensor of the multiple sensors, and determining, based on the similarity measures, a tracked object track for a tracked object of the multiple objects.

Yet another aspect of the disclosed implementations is a computer-readable storage medium storing instructions. The instructions causing a processor to perform a method that includes receiving position information for multiple objects within a portion of a vehicle transportation network, the position information obtained from multiple sensors within the portion of the vehicle transportation network, determining, using the position information of a respective sensors of the multiple sensors, a respective track for objects of the multiple objects, determining respective similarity measures for pairs of tracks, wherein each track of a pair of tracks is associated with a different sensor of the multiple sensors, determining, based on the similarity measures, a tracked object track for a tracked object of the multiple objects, outputting the position information to an object fusion and tracking module that outputs any un-matched objects of the multiple objects to a world module as separate objects, wherein an un-matched object is an object associated with only one track, and outputting tracks for those of the multiple sensors forming the tracked object track to the object fusion and tracking module to output matched objects of the multiple objects to the world model as a single object.

These and other aspects of the present disclosure are disclosed in the following detailed description of the embodiments, the appended claims, and the accompanying figures.

### BRIEF DESCRIPTION OF THE DRAWINGS

The disclosed technology is best understood from the following detailed description when read in conjunction with the accompanying drawings. It is emphasized that, according to common practice, the various features of the drawings may not be to scale. On the contrary, the dimensions of the various features may be arbitrarily expanded or reduced for clarity. Further, like reference numbers refer to like elements throughout the drawings unless otherwise noted.

FIG. 1 is a diagram of an example of a portion of a vehicle in which the aspects, features, and elements disclosed herein may be implemented.

FIG. 2 is a diagram of an example of a portion of a vehicle transportation and communication system in which the aspects, features, and elements disclosed herein may be implemented.

FIG. 3 is a diagram of a system in which the track based moving object association disclosed herein may be used.

FIG. 4A is a diagram of an example of object association for multiple sensors.

FIG. 4B is a diagram of examples of techniques for object fusion.

FIG. 4C is a diagram of an example of tracking and prediction of a moving object.

FIG. 4D is a diagram of an example of calibration of a sensor.

FIG. 5 is a diagram of a first example of track based moving object association according to the teachings herein.

FIGS. 6A-6C are diagrams illustrating object association and tracking according to a technique that can be used in the first example of FIG. 5.

FIGS. 7A-7C are diagrams illustrating details of the EM algorithm according to FIG. 5.

FIG. 8 is a diagram of heterogenous latency and buffering of the track based moving object association according to FIG. 5.

FIG. 9 is flowchart diagram of a process of a track based moving object association according to the teachings herein.

FIG. 10 is a diagram of a second example of track based moving object association according to the teachings herein.

FIG. 11 is a diagram of using multiple sensors in the second example of track based moving object association according to FIG. 10.

### DETAILED DESCRIPTION

A vehicle may traverse a portion of a vehicle transportation network. The vehicle transportation network can include one or more unnavigable areas, such as a building; one or more partially navigable areas, such as a parking area (e.g., a parking lot, a parking space, etc.); one or more navigable areas, such as roads (which include lanes, medians, intersections, etc.); or a combination thereof. The vehicle may use its native sensors, which generate or capture data corresponding to an operational environment of the vehicle, or a portion thereof, while the vehicle traverses the vehicle transportation network. The vehicle may then use this data to identify potential collisions or hazards (e.g., other road users), which can be used for notifications to an operator, for input to safety systems, for input into advanced driver-assistance systems (ADAS), or some combination thereof.

As mentioned above, data from other sensors is available for the purpose of identifying potential collisions or hazards. Processing the collected transportation network data from the vehicle sensors and from other vehicles and infrastructure sensors is complicated by its large volume. A large volume of data tends to increase latency in providing insights into the future behavior. Moreover, the data regarding a single road user (e.g., from different sources) can be inconsistent or contradictory at any given point in time.

Various solutions described herein improve operation of a vehicle traversing a vehicle transportation network by improving object association in the presence of distributed sensing using track-based techniques. To describe some implementations of the track based moving object association herein in greater detail, reference is first made to the environment in which this disclosure may be implemented.

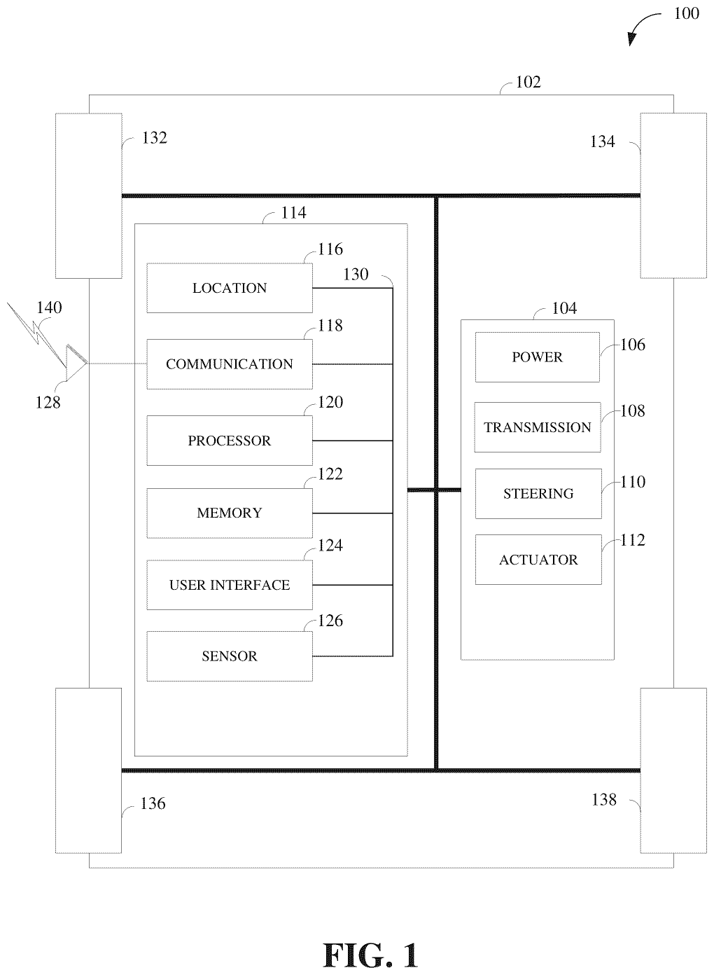

FIG. 1 is a diagram of an example of a portion of a vehicle 100 in which the aspects, features, and elements disclosed herein may be implemented. The vehicle 100 includes a chassis 102, a powertrain 104, a controller 114, wheels 132/134/136/138, and may include any other element or combination of elements of a vehicle. Although the vehicle 100 is shown as including four wheels 132/134/136/138 for simplicity, any other propulsion device or devices, such as a propeller or tread, may be used. In FIG. 1, the lines interconnecting elements, such as the powertrain 104, the controller 114, and the wheels 132/134/136/138, indicate that information, such as data or control signals; power, such as electrical power or torque; or both information and power may be communicated between the respective elements. For example, the controller 114 may receive power from the powertrain 104 and communicate with the powertrain 104, the wheels 132/134/136/138, or both, to control the vehicle 100, which can include accelerating, decelerating, steering, or otherwise controlling the vehicle 100.

The powertrain 104 includes a power source 106, a transmission 108, a steering unit 110, a vehicle actuator 112, and may include any other element or combination of elements of a powertrain, such as a suspension, a drive shaft, axles, or an exhaust system. Although shown separately, the wheels 132/134/136/138 may be included in the powertrain 104.

The power source 106 may be any device or combination of devices operative to provide energy, such as electrical energy, thermal energy, or kinetic energy. For example, the power source 106 includes an engine, such as an internal combustion engine, an electric motor, or a combination of an internal combustion engine and an electric motor and is operative (or configured) to provide kinetic energy as a motive force to one or more of the wheels 132/134/136/138. In some embodiments, the power source 106 includes a potential energy unit, such as one or more dry cell batteries, such as nickel-cadmium (NiCd), nickel-zinc (NiZn), nickel metal hydride (NiMH), lithium-ion (Li-ion); solar cells; fuel cells; or any other device capable of providing energy.

The transmission 108 receives energy, such as kinetic energy, from the power source 106 and transmits the energy to the wheels 132/134/136/138 to provide a motive force. The transmission 108 may be controlled by the controller 114, the vehicle actuator 112, or both. The steering unit 110 may be controlled by the controller 114, the vehicle actuator 112, or both and controls the wheels 132/134/136/138 to steer the vehicle. The vehicle actuator 112 may receive signals from the controller 114 and may actuate or control the power source 106, the transmission 108, the steering unit 110, or any combination thereof to operate the vehicle 100.

In the illustrated embodiment, the controller 114 includes a location unit 116, an electronic communication unit 118, a processor 120, a memory 122, a user interface 124, a sensor 126, and an electronic communication interface 128. Although shown as a single unit, any one or more elements of the controller 114 may be integrated into any number of separate physical units. For example, the user interface 124 and the processor 120 may be integrated in a first physical unit, and the memory 122 may be integrated in a second physical unit. Although not shown in FIG. 1, the controller 114 may include a power source, such as a battery. Although shown as separate elements, the location unit 116, the electronic communication unit 118, the processor 120, the memory 122, the user interface 124, the sensor 126, the electronic communication interface 128, or any combination thereof can be integrated in one or more electronic units, circuits, or chips.

In some embodiments, the processor 120 includes any device or combination of devices, now-existing or hereafter developed, capable of manipulating or processing a signal or other information, for example optical processors, quantum processors, molecular processors, or a combination thereof. For example, the processor 120 may include one or more special-purpose processors, one or more digital signal processors, one or more microprocessors, one or more controllers, one or more microcontrollers, one or more integrated circuits, one or more Application Specific Integrated Circuits, one or more Field Programmable Gate Arrays, one or more programmable logic arrays, one or more programmable logic controllers, one or more state machines, or any combination thereof. The processor 120 may be operatively coupled with the location unit 116, the memory 122, the electronic communication interface 128, the electronic communication unit 118, the user interface 124, the sensor 126, the powertrain 104, or any combination thereof. For example, the processor may be operatively coupled with the memory 122 via a communication bus 130.

The processor 120 may be configured to execute instructions. Such instructions may include instructions for remote operation, which may be used to operate the vehicle 100 from a remote location, including the operations center. The instructions for remote operation may be stored in the vehicle 100 or received from an external source, such as a traffic management center, or server computing devices, which may include cloud-based server computing devices. The processor 120 may also implement some or all of the proactive risk mitigation described herein.

The memory 122 may include any tangible non-transitory computer-usable or computer-readable medium capable of, for example, containing, storing, communicating, or transporting machine-readable instructions or any information associated therewith, for use by or in connection with the processor 120. The memory 122 may include, for example, one or more solid state drives, one or more memory cards, one or more removable media, one or more read-only memories (ROM), one or more random-access memories (RAM), one or more registers, one or more low power double data rate (LPDDR) memories, one or more cache memories, one or more disks (including a hard disk, a floppy disk, or an optical disk), a magnetic or optical card, or any type of non-transitory media suitable for storing electronic information, or any combination thereof.

The electronic communication interface 128 may be a wireless antenna, as shown, a wired communication port, an optical communication port, or any other wired or wireless unit capable of interfacing with a wired or wireless electronic communication medium 140.

The electronic communication unit 118 may be configured to transmit or receive signals via the wired or wireless electronic communication medium 140, such as via the electronic communication interface 128. Although not explicitly shown in FIG. 1, the electronic communication unit 118 is configured to transmit, receive, or both via any wired or wireless communication medium, such as radio frequency (RF), ultraviolet (UV), visible light, fiber optic, wire line, or a combination thereof. Although FIG. 1 shows a single electronic communication unit 118 and a single electronic communication interface 128, any number of communication units and any number of communication interfaces may be used. In some embodiments, the electronic communication unit 118 can include a dedicated short-range communications (DSRC) unit, a wireless safety unit (WSU), Institute of Electrical and Electronics Engineers (IEEE) 802.11p (WiFi-P), or a combination thereof.

The location unit 116 may determine geolocation information, including but not limited to longitude, latitude, elevation, direction of travel, or speed, of the vehicle 100. For example, the location unit includes a global positioning system (GPS) unit, such as a Wide Area Augmentation System (WAAS) enabled National Marine Electronics Association (NMEA) unit, a radio triangulation unit, or a combination thereof. The location unit 116 can be used to obtain information that represents, for example, a current heading of the vehicle 100, a current position of the vehicle 100 in two or three dimensions, a current angular orientation of the vehicle 100, or a combination thereof.

The user interface 124 may include any unit capable of being used as an interface by a person, including any of a virtual keypad, a physical keypad, a touchpad, a display, a touchscreen, a speaker, a microphone, a video camera, a sensor, and a printer. The user interface 124 may be operatively coupled with the processor 120, as shown, or with any other element of the controller 114. Although shown as a single unit, the user interface 124 can include one or more physical units. For example, the user interface 124 includes an audio interface for performing audio communication with a person, and a touch display for performing visual and touch-based communication with the person.

The sensor 126 may include one or more sensors, such as an array of sensors, which may be operable to provide information that may be used to control the vehicle. The sensor 126 can provide information regarding current operating characteristics of the vehicle or its surroundings. The sensor 126 includes, for example, a speed sensor, acceleration sensors, a steering angle sensor, traction-related sensors, braking-related sensors, or any sensor, or combination of sensors, that is operable to report information regarding some aspect of the current dynamic situation of the vehicle 100.

In some embodiments, the sensor 126 includes sensors that are operable to obtain information regarding the physical environment surrounding the vehicle 100. For example, one or more sensors detect road geometry and obstacles, such as fixed obstacles, vehicles, cyclists, and pedestrians. The sensor 126 can be or include one or more video cameras, laser-sensing systems, infrared-sensing systems, acoustic-sensing systems, or any other suitable type of on-vehicle environmental sensing device, or combination of devices, now known or later developed. The sensor 126 and the location unit 116 may be combined.

Although not shown separately, the vehicle 100 may include a trajectory controller. For example, the controller 114 may include a trajectory controller. The trajectory controller may be operable to obtain information describing a current state of the vehicle 100 and a route planned for the vehicle 100, and, based on this information, to determine and optimize a trajectory for the vehicle 100. In some embodiments, the trajectory controller outputs signals operable to control the vehicle 100 such that the vehicle 100 follows the trajectory that is determined by the trajectory controller. For example, the output of the trajectory controller can be an optimized trajectory that may be supplied to the powertrain 104, the wheels 132/134/136/138, or both. The optimized trajectory can be a control input, such as a set of steering angles, with each steering angle corresponding to a point in time or a position. The optimized trajectory can be one or more paths, lines, curves, or a combination thereof.

One or more of the wheels 132/134/136/138 may be a steered wheel, which is pivoted to a steering angle under control of the steering unit 110; a propelled wheel, which is torqued to propel the vehicle 100 under control of the transmission 108; or a steered and propelled wheel that steers and propels the vehicle 100.

A vehicle may include units or elements not shown in FIG. 1, such as an enclosure, a Bluetooth® module, a frequency modulated (FM) radio unit, a Near-Field Communication (NFC) module, a liquid crystal display (LCD) display unit, an organic light-emitting diode (OLED) display unit, a speaker, or any combination thereof.

The vehicle, such as the vehicle 100, may be an autonomous vehicle or a semi-autonomous vehicle. For example, as used herein, an autonomous vehicle as used herein should be understood to encompass a vehicle that includes an advanced driver assist system (ADAS). An ADAS can automate, adapt, and/or enhance vehicle systems for safety and better driving such as by circumventing or otherwise correcting driver errors.

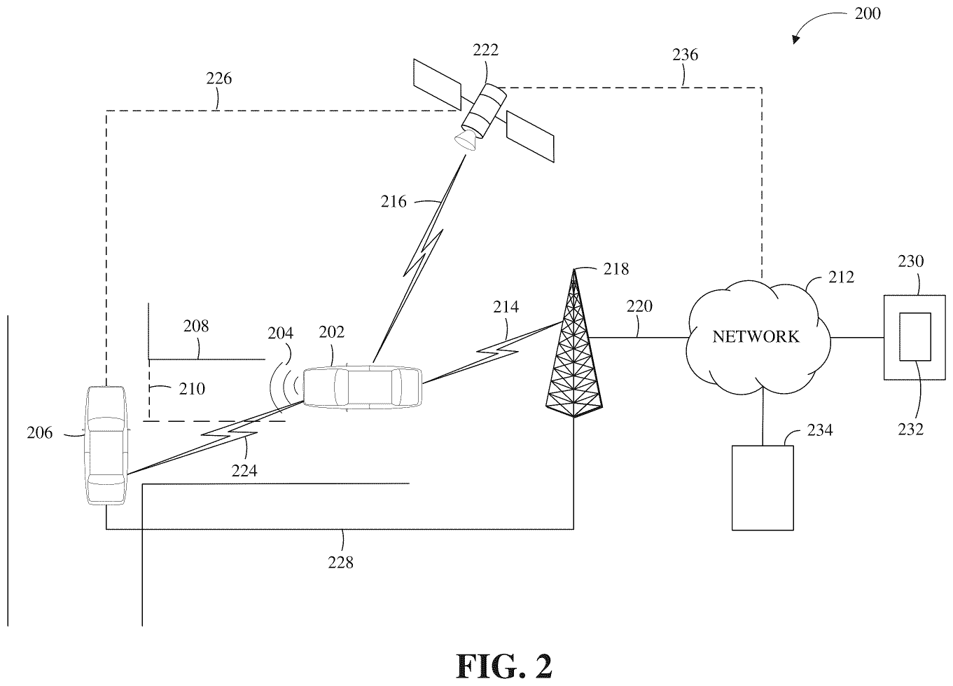

FIG. 2 is a diagram of an example of a portion of a vehicle transportation and communication system 200 in which the aspects, features, and elements disclosed herein may be implemented. The vehicle transportation and communication system 200 includes a vehicle 202, such as the vehicle 100 shown in FIG. 1, and one or more external objects, such as an external object 206, which can include any form of transportation, such as the vehicle 100 shown in FIG. 1, a pedestrian, cyclist, as well as any form of a structure, such as a building. The vehicle 202 may travel via one or more portions of a transportation network 208 and may communicate with the external object 206 via one or more of an electronic communication network 212. Although not explicitly shown in FIG. 2, a vehicle may traverse an area that is not expressly or completely included in a transportation network, such as an off-road area. In some embodiments, the transportation network 208 may include one or more of a vehicle detection sensor 210, such as an inductive loop sensor, which may be used to detect the movement of vehicles on the transportation network 208.

The electronic communication network 212 may be a multiple access system that provides for communication, such as voice communication, data communication, video communication, messaging communication, or a combination thereof, between the vehicle 202, the external object 206, and an operations center 230. For example, the vehicle 202 or the external object 206 may receive information, such as information representing the transportation network 208, from the operations center 230 via the electronic communication network 212.

The operations center 230 includes a controller apparatus 232, which includes some or all of the features of the controller 114 shown in FIG. 1. The controller apparatus 232 can monitor and coordinate the movement of vehicles, including autonomous vehicles. The controller apparatus 232 may monitor the state or condition of vehicles, such as the vehicle 202, and external objects, such as the external object 206. The controller apparatus 232 can receive vehicle data and infrastructure data including any of: vehicle velocity; vehicle location; vehicle operational state; vehicle destination; vehicle route; vehicle sensor data; external object velocity; external object location; external object operational state; external object destination; external object route; and external object sensor data.

Further, the controller apparatus 232 can establish remote control over one or more vehicles, such as the vehicle 202, or external objects, such as the external object 206. In this way, the controller apparatus 232 may teleoperate the vehicles or external objects from a remote location. The controller apparatus 232 may exchange (send or receive) state data with vehicles, external objects, or a computing device, such as the vehicle 202, the external object 206, or a server computing device 234, via a wireless communication link, such as the wireless communication link 226, or a wired communication link, such as the wired communication link 228.

The server computing device 234 may include one or more server computing devices, which may exchange (send or receive) state signal data with one or more vehicles or computing devices, including the vehicle 202, the external object 206, or the operations center 230, via the electronic communication network 212.

In some embodiments, the vehicle 202 or the external object 206 communicates via the wired communication link 228, a wireless communication link 214/216/224, or a combination of any number or types of wired or wireless communication links. For example, as shown, the vehicle 202 or the external object 206 communicates via a terrestrial wireless communication link 214, via a non-terrestrial wireless communication link 216, or via a combination thereof. In some implementations, a terrestrial wireless communication link 214 includes an Ethernet link, a serial link, a Bluetooth link, an infrared (IR) link, an ultraviolet (UV) link, or any link capable of electronic communication.

A vehicle, such as the vehicle 202, or an external object, such as the external object 206, may communicate with another vehicle, external object, or the operations center 230. For example, a host, or subject, vehicle 202 may receive one or more automated inter-vehicle messages, such as a basic safety message (BSM), from the operations center 230 via a direct communication link 224 or via an electronic communication network 212. For example, the operations center 230 may broadcast the message to host vehicles within a defined broadcast range, such as three hundred meters, or to a defined geographical area. In some embodiments, the vehicle 202 receives a message via a third party, such as a signal repeater (not shown) or another remote vehicle (not shown). In some embodiments, the vehicle 202 or the external object 206 transmits one or more automated inter-vehicle messages periodically based on a defined interval, such as one hundred milliseconds.

The vehicle 202 may communicate with the electronic communication network 212 via an access point 218. The access point 218, which may include a computing device, is configured to communicate with the vehicle 202, with the electronic communication network 212, with the operations center 230, or with a combination thereof via wired or wireless communication links 214/220. For example, an access point 218 is a base station, a base transceiver station (BTS), a Node-B, an enhanced Node-B (eNode-B), a Home Node-B (HNode-B), a wireless router, a wired router, a hub, a relay, a switch, or any similar wired or wireless device located at, e.g., a cell tower. Although shown as a single unit, an access point can include any number of interconnected elements. The access point 218 may be a cellular access point.

The vehicle 202 may communicate with the electronic communication network 212 via a satellite 222 or other non-terrestrial communication device. The satellite 222, which may include a computing device, may be configured to communicate with the vehicle 202, with the electronic communication network 212, with the operations center 230, or with a combination thereof via one or more communication links 216/236. Although shown as a single unit, a satellite can include any number of interconnected elements.

The electronic communication network 212 may be any type of network configured to provide for voice, data, or any other type of electronic communication. For example, the electronic communication network 212 includes a local area network (LAN), a wide area network (WAN), a virtual private network (VPN), a mobile or cellular telephone network, the Internet, or any other electronic communication system. The electronic communication network 212 may use a communication protocol, such as the Transmission Control Protocol (TCP), the User Datagram Protocol (UDP), the Internet Protocol (IP), the Real-time Transport Protocol (RTP), the Hyper Text Transport Protocol (HTTP), or a combination thereof. Although shown as a single unit, an electronic communication network can include any number of interconnected elements.

In some embodiments, the vehicle 202 communicates with the operations center 230 via the electronic communication network 212, access point 218, or satellite 222. The operations center 230 may include one or more computing devices, which are able to exchange (send or receive) data from a vehicle, such as the vehicle 202; data from external objects, including the external object 206; or data from a computing device, such as the server computing device 234.

In some embodiments, the vehicle 202 identifies a portion or condition of the transportation network 208. For example, the vehicle 202 may include one or more on-vehicle sensors 204, such as the sensor 126 shown in FIG. 1, which includes a speed sensor, a wheel speed sensor, a camera, a gyroscope, an optical sensor, a laser sensor, a radar sensor, a sonic sensor, or any other sensor or device or combination thereof capable of determining or identifying a portion or condition of the transportation network 208.

The vehicle 202 may traverse one or more portions of the transportation network 208 using information communicated via the electronic communication network 212, such as information representing the transportation network 208, information identified by one or more on-vehicle sensors 204, or a combination thereof. The external object 206 may be capable of all or some of the communications and actions described above with respect to the vehicle 202.

For simplicity, FIG. 2 shows the vehicle 202 as the host vehicle, the external object 206, the transportation network 208, the electronic communication network 212, and the operations center 230. However, any number of vehicles, networks, or computing devices may be used. In some embodiments, the vehicle transportation and communication system 200 includes devices, units, or elements not shown in FIG. 2.

Although the vehicle 202 is shown communicating with the operations center 230 via the electronic communication network 212, the vehicle 202 (and the external object 206) may communicate with the operations center 230 via any number of direct or indirect communication links. For example, the vehicle 202 or the external object 206 may communicate with the operations center 230 via a direct communication link, such as a Bluetooth communication link. Although, for simplicity, FIG. 2 shows one of the transportation network 208 and one of the electronic communication network 212, any number of networks or communication devices may be used.

The external object 206 is illustrated as a second, remote vehicle in FIG. 2. An external object is not limited to another vehicle. An external object may be any infrastructure element, for example, a fence, a sign, a building, etc., that has the ability transmit data to the operations center 230. The data may be, for example, sensor data from the infrastructure element.

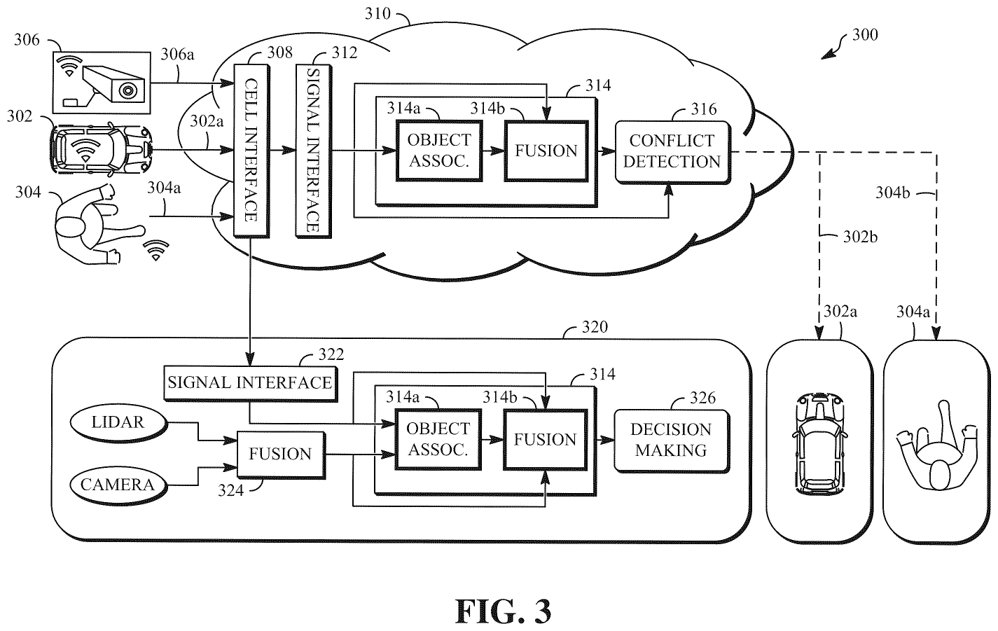

FIG. 3 is a diagram of a system 300 in which the track based moving object association disclosed herein may be used. The system 300 may be implemented in a vehicle 302 transportation and communication system, such as the vehicle transportation and communication system 200, as discussed in more detail below. Although described with respect to a vehicle 302 traveling through a vehicle transportation network, such as the vehicle transportation network 208, the teachings herein may be used in any area navigable by a vehicle. An intersection within the vehicle transportation network, as used herein, encompasses vehicle-navigable paths that intersect each other, including entrances and exits to parking lots/garages and paths within (e.g., between parking spaces in) parking lots. Other examples of the system 300 can include more, fewer, or other components. In some examples, the components can be combined; in other examples, a component can be divided into more than one component.

In general, FIG. 3 illustrates a multi-layered architecture that uses multi-access edge computing (MEC) to process sensor data, optionally including cooperative driving automation (CDA) messages sent from vehicles and infrastructure sensors. The MEC then sends back notifications to one or more vehicles and possibly other road users (ORU), such as pedestrians or bicycles, to avoid collisions. These ORUs may be respectively referred to as a non-motorized road user herein. As shown, the system 300 desirably uses standards-based communications (e.g., a standards-based communication protocol) that eliminates the requirement for direct vehicle-to-vehicle (V2V) or vehicle-to-pedestrian (V2P) communications. In the example described, network cellular vehicle-to-vehicle (C-V2X) (also called Network C-V2X) is used for data/message exchange. The standard-based communications are based on the Society of Automotive Engineers (SAE) J3216 Standard for Cooperative Driving, but any suitable communication protocol may be used that is capable of wireless communication, whether or not using cellular technology, is possible.

The system 300 receives respective signals 302a from one or more connected vehicles 302, which may be a vehicle 100, 202. The signals 302a may include position, speed, or any other information. The signals 302a may comprise a BSM (e.g., SAE 2735 BSM).

The system 300 receives respective signals 304a from one or more ORUs, such as the pedestrian 304. The signals 304a may include position, speed, or any other information. The signals 304a may comprise a personal safety message (PSM) (e.g., SAE 2735 BSM). An ORU or non-motorized road user carries a communication device, such as a cellular device, to transmit a PSM and optionally receive notifications as described in more detail below. A cellular device, also referred to as a cellular-enabled device may be supported by a road user in any suitable manner.

The system 300 receives respective signals 306a from one or more infrastructure sensors, such as an infrastructure camera 306. An infrastructure sensor may be associated with infrastructure within the vehicle transportation network. An infrastructure sensor monitors at least a portion of an intersection. An infrastructure sensor may be incorporated into a standalone roadside unit (RSU), or may be mounted on a building, a traffic light, a streetlight, etc. The infrastructure camera 306 can send signals 306a including information about what is detected, e.g., vehicles, ORUs, autonomous vehicles (AV). The signals 306a may include position, speed, or any other information. The signals 306a may comprise a BSM when a vehicle is detected and a PSM when a ORU is detected.

The signals 302a, 304a, and 306a are received at a cellular interface 308, which may comprise a wireless cellular transceiver (or a combination of a wireless receiver and a wireless transmitter) or an access point, such as the access point 218, located at a cell tower. Processing the received data may be performed at the MEC 310. The MEC 310 includes a signal interface 312, a system to produce a shared world model (SWM) 314, and a conflict detection module 316. The MEC 310 sits at the edge of a mobile network (as opposed to cloud services on the public internet), such as at the network 212. For this reason, the MEC 310 provides low latency for this application. Further, because the computing happens on the cloud using, for example, a server computing device 234, the MEC 310 is highly scalable as compared to performing the computing solely within vehicles, e.g., using V2V communications.

In the implementation shown, SAE standards-based messages are sent from vehicles 302 to the MEC 310, from pedestrians 304, from infrastructure cameras 306, ORUs, or from any combination thereof, using Network C-V2X over a cellular network. In this description, a connected vehicle is one that is connected to the cellular network, either directly or by a cellular device of an operator. A vehicle or an AV is other than a connected vehicle. The messages are sent over a cellular network, such as the mobile network of a particular cellular provider, to a cellular interface, such as the cellular interface 308. The messages may be sent over a 4G network, a Long Term Evolution (LTE) network, such as 4G LTE, a 5G network, or any other cellular network now known or hereinafter developed. The messages may be sent using the electronic communication unit 118 in some implementations. At least some of the messages may be sent by any other wireless communication system.

Although not shown, a respective interface corresponding to the cell interface 308 may be located at a connected vehicle, such as the connected vehicle 302, at infrastructure sensor such as the infrastructure camera 306, at a cellular-enabled device (e.g., a mobile phone) of an ORU, such as the pedestrian 304. In this way, sensor data such as signals 302a, 304a, and 306a (latitude, longitude, pose, speed, etc., or any combination thereof) may be encoded or otherwise converted for transmission to the cell interface 308.

The cellular interface 308 receives the messages and distributes them to one or more signal interfaces 312 for a MEC 310. That is, the MEC 310 is scalable. Accordingly, the signal interface 312 may be duplicated, along with the subsequent components of the MEC 310, to accommodate different portions of the transportation network, data above a defined amount, etc. The cellular interface 308 may thus act as a broker for the messages to determine which MEC 310 should process the incoming messages. The messages may be transmitted through a network to the appropriate signal interface 312. To the extent that the messages are encoded, the signal interface 312 can convert the messages to a format for use by the remaining components of the system 300, namely a shared world model (SWM) 314 and the conflict detection module 316.

The MEC 310 uses object association and fusion to generate the SWM 314 that can be used for prediction and conflict detection. As can be seen from the above, the MEC 310 may receive data from more than one source regarding the same object. At an intersection, for example, the MEC 310 may receive signals 302a regarding the position, etc., of the connected vehicle 302 and receive signals 306a that include information regarding the position, etc., of the connected vehicle 302. Similarly, the MEC 310 may receive signals 304a regarding the position, etc., of the ORU (e.g., the pedestrian 304) and receive signals 302a, 306a that include information regarding the position, etc., of the ORU. The SWM 314 receives the signals 302a, 304a, and 306a, determines (e.g., converts to, detects, etc.) objects from the sensor data, fuses objects detected by multiple sources (if any), and generates a single world view of the road users and their surroundings.

As shown in FIG. 3, the SWM 314 comprises object association 314a and object fusion 314b. In some implementations, the object association 314a may determine objects (e.g., road users) from the received signals 302a, 304a, 306a, e.g., the BSM and PSM messages. For example, object association 314a may associate location information within each of the messages with a respective road user, e.g., a connected vehicle, an ORU (e.g., a pedestrian or non-motorized vehicle), or an autonomous vehicle within the vehicle transportation network. The object association 314a may generate or maintain a state for at least some of the determined objects, such as a velocity, a pose, a geometry (such as width, height, and depth), a classification (e.g., bicycle, large truck, pedestrian, road sign, etc.), a location, or some combination thereof.

The object fusion 314b may receive the sensed objects over time, in addition to the signals, such as the signals 302a, 304a, 306a, e.g., the BSM and PSM messages. Using data such as the heading and velocity information, for example, sensed objects may be fused where appropriate. That is, the data associated with each object may be compared to determine whether respective objects identified by separate messages may be the same object. The more similar the data is, the more likely two objects are the same. The data of the objects determined to be the same object are fused to generate a tracked object at positions over time. Its fused trajectory (e.g., based on a combination of heading, pose, and speed, for example) may be used in the conflict detection module 316. That is, at the output of the SWM 314, each road user is a separate tracked object with a respective trajectory or intended path to supply to the conflict detection module 316 for use therein.

Although described as separate components of the SWM 314, a shared world model used in the MEC 310 may require many overlapping detections to produce a result. That is, the object association and fusion may be coupled and performed iteratively. While this implementation of a shared world model may be used in the MEC 310, a particularly desirable implementation of the SWM 314 is described in detail below.

The conflict detection module 316 receives the tracked objects and their respective trajectories. The conflict detection module 316 uses this information to predict a possible collision between a connected vehicle, such as the connected vehicle 302, and nearby vehicles or ORUs, such as the pedestrian 304, traveling through a vehicle transportation network. The conflict detection module 316 does this, in some implementations, by using the trajectories over a look-ahead period to determine where each of the road users will be at time points in the look-ahead period.

In some examples herein, an infrastructure sensor of a RSU may detect non-connected road users (e.g., pedestrians) and connect to connected road users (e.g., connected vehicles). For non-connected road uses, prediction can be done by measurements from infrastructure sensor(s) over time (e.g., speed and heading). For connected road users, the intended path can be similarly predicted from such measurements. The predicted/intended trajectories of the road users can then be compared to determine if conflict would occur.

For conflict detection between a non-connected road user (e.g., a pedestrian or non-connected vehicle) and a connected vehicle, the locations at time points or steps in the look-ahead period that the non-connected user is likely to reach are determined, as are those for the connected vehicle, e.g., using the predicted/intended paths and speeds. The distance between paths at future time steps may be computed. Then, when the distance between the paths is shorter than a threshold, a conflict may be detected. Stated differently, if two or more road users are within a defined proximity of each other at a particular time point, the conflict detection module 316 can identify a potential conflict and optionally send a notification 302b to the connected vehicle, a notification 304b to any other affected road user, or both.

While the system 300 shows components located external of an ego vehicle for decision-making, some or all components may be incorporated into a vehicle such as an AV or a connected autonomous vehicle (CAV) to improve operation of the vehicle. In FIG. 3, a CAV 320 corresponds, in part, to a conventional AV, in that multiple sensors can provide inputs into a fusion unit 324 (object association and fusion). The hardware sensors shown include a camera and a Light Detection and Ranging sensor (LiDAR). Other sensors conventionally found on an autonomous vehicle may include a GPS and a radio detection and ranging (RADAR) sensor. The fusion unit 324 receives the sensor signals and fuses the identified objects into tracked objects for inclusion in a shared world model executed by a processor of the CAV 320, such as the processor 120 of FIG. 1.

An autonomous vehicle conventionally has a shared world model (e.g., the output of the fusion unit 324). According to the CAV 320, a shared world model of the CAV 320 can also receive the BSM and PSM messages from the cellular interface 308 to refine the shared world model. That is, in addition to reconciling its own sensor values to identify objects using the fusion unit 324, the CAV 320 may include another instance of the SWM 314 executed by a processor of the CAV 320, such as the processor 120 of FIG. 1, to generate tracked objects and their respective trajectories. The shared world model of the CAV 320 may also be different from (i.e., operate differently from) the SWM 314 in some implementations. In either event, the tracked objects and their respective trajectories are sent to a decision-making module 326. The CAV 320 does not need a separate conflict detection module, like the conflict detection module 316, because the decision-making module 326 may be a conventional module for decision making that already addresses conflict detection and resolution.

As mentioned briefly above, the large volume of sensor data (transportation network data) collected from distributed sensing (e.g., vehicles, infrastructure sensors, ORUs, etc.) can complicate the processing and usefulness of that data in identifying unique road users for a vehicle to navigate a vehicle transportation network. More specifically, associating and fusing sensor measurements of road users made by spatially distributed sensors on fixed infrastructure, moving vehicles, and ORUs (road user GPS devices) is complicated by clutter, heterogenous sensors, communications constraints, heterogenous and variable latencies, etc.

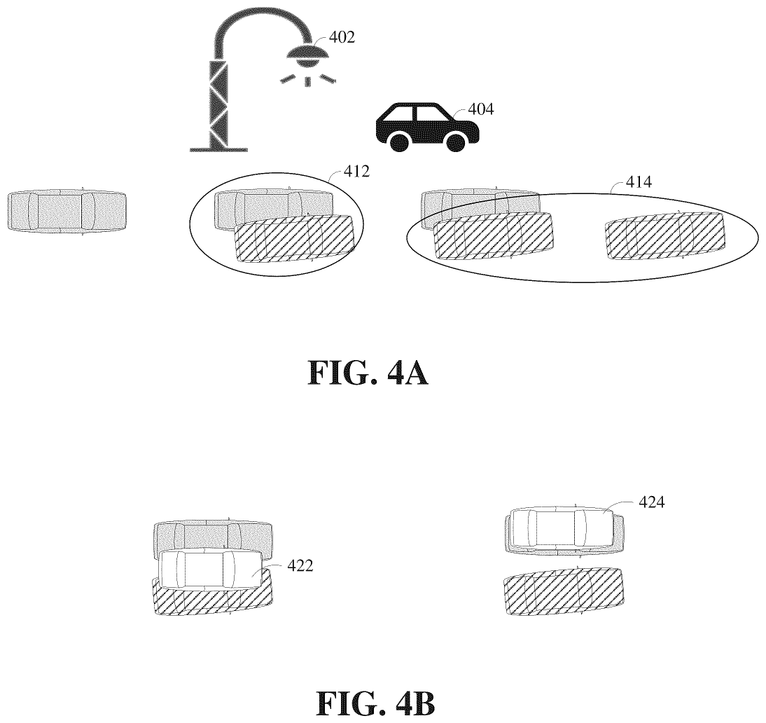

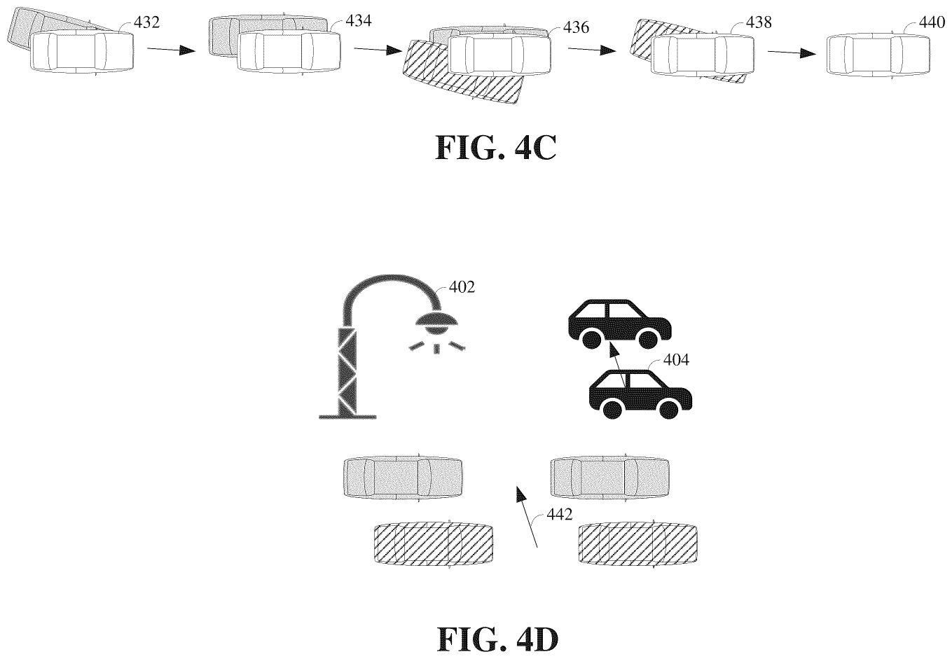

These difficulties and certain terms used herein are explained with initial reference to FIGS. 4A-4D.

FIG. 4A is a diagram of an example of object association for multiple sensors. Object association may be considered the act of matching corresponding objects tracked by different sensors. In FIG. 4A, a first sensor, such as an infrastructure camera 306, is located at an infrastructure device 402. The sensor data from the infrastructure device 402 includes data related to a moving vehicle that corresponds to the shaded vehicles shown in FIG. 4A. A second sensor is located at the vehicle 404, which may be the ego vehicle. The sensor data from the vehicle 404 includes data related to a moving vehicle that corresponds to the dashed vehicles shown in FIG. 4A. Problems with object association include determining whether different sensors at substantially the same time are detecting the same object as shown by situation 412 and determining whether the same sensor at different times are detecting the same object as shown by situation 414. As discussed in additional detail below, object association may be done based on matching appearance, shape, and/or location.

FIG. 4B is a diagram of examples of techniques for object fusion. Object fusion may be considered the act of combining separate measurements from different sensors of the same (associated) objects into a single, improved, estimate. FIG. 4B is an illustration of two sensor outputs from the infrastructure device 402 (i.e., the shaded vehicle) and the vehicle 404 (i.e., the dashed vehicle) in FIG. 4A. Object association has identified each of the sensor outputs as being related to a single object. Object fusion may identify a pose and a classification of the object using the sensor outputs. For example, to the left in FIG. 4B, object fusion generates a single object 422 from the separate sensor outputs using conventional Kalman filtering (e.g., a weighted average). To the right in FIG. 4B, object fusion generates a single object 424 using the best sensor source for the particular desired data of the single object 424. For example, the pose of the single object 424 can be obtained from Light Detection and Ranging (LiDAR) data, while the classification of the single object 424 can be obtained from another source, such as combinations of camera images from sensors of the vehicle 404. The single objects 422, 424 resulting from object fusion are shown as unshaded vehicles.

FIG. 4C is a diagram of an example of tracking and prediction of a moving object. Once an object, such as the single object 422 or 424, has a stable identifier (ID) across multiple sensor readings, and the fused object is tracked for multiple time points 432, 434, 436, 438, a short-term prediction is made for future time points (only one prediction 440 is shown in FIG. 4C). The prediction may be used for vehicle control as described previously.

FIG. 4D is a diagram of an example of calibration of a sensor. FIG. 4D shows extrinsic calibration, and more particularly shows pose correction using extrinsic calibration. The position of the infrastructure device 402 is known, which is an example of an extrinsic object. The position of the vehicle 404 results in sensed positions for the object (e.g., the dashed vehicle) that vary from those sensed for the same object by the infrastructure device 402 by the distance indicated by the arrow 442. As a result, the pose of the vehicle 404 can be similarly adjusted based on this extrinsic calibration for the future object association and fusion of its sensor outputs.

A track to tracked object association and fusion architecture 500, which is a first example of track based moving object association according to the teachings herein, is next described. In the architecture 500, a vehicle 502 includes LiDAR as an example of an on-board sensor. The vehicle 502 may be an autonomous vehicle in some implementations. Another sensor is provided by an infrastructure device 504, which sensor may be a, e.g., smart, camera that maintains its data on a cloud or other remote storage. Another source of inputs may be, e.g., a GPS signal from a connected vehicle 506. For this example, the connected vehicle 506 is treated as the tracked object 550, but this is not required. The tracked object 550 may be another object moving within a vehicle transportation network.

The vehicle 502 may include or is connected to a first object tracker 512. The sensor of the infrastructure device 504 is connected to a second object tracker 514, which may be located on or connected to the cloud or other remote storage to access the data. Each of the first object tracker 512 and the second object tracker 514 may be any multiple object tracker. For example, an appearance based object association may be used alone or in combination with other techniques. An appearance based object association associates object detections of similar appearance using a metric such as histogram similarity, template matching, and/or deep neural network (DNN) for object detection. While appearance based object detection works well for matching objects with associated images, it is not the best technique for the applications described herein. The match can be instant, but high levels of computation are required. Further, the technique is not generally suitable for heterogenous sensors.

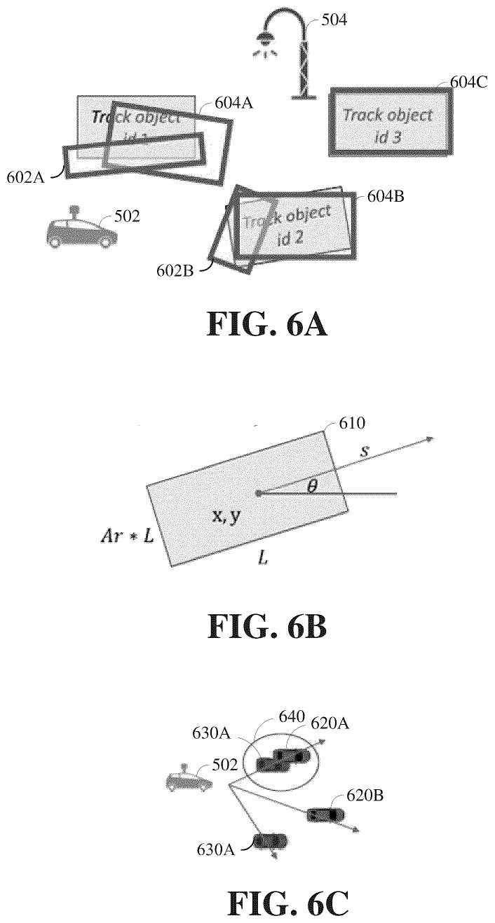

Instead, in an example, each of the first and second object tracker 512, 514 implements a modified process to that described in Bewley, et al., “Simple Online and Realtime Tracking”, https://arxiv.org/abs/1602.00763v2 [cs.CV]7 Jul. 2017. More specifically, the object association and tracking use extended Kalman filtering with position and shape based object association, which can be described with regards to FIGS. 6A through 6C.

A position and shape based object association associates object detections at similar locations and shapes. Metrics used for these object associations can include a (normalized) distance between respective detections, an Intersection of Union (IoU) score, or a normalized IoU score. The object trackers respectively determine, from the positions (locations) and shapes of detected objects, which detected objects are the same object and which detected objects are difference objects. For example, and referring to FIG. 6A, the sensor of the vehicle 502 detects an object within the bounding box 602A and an object within the bounding box 602B. The object tracker 512 determines, using the position and shaped based object association that the objects are separate objects, respectively track object id 1 and track object id 2, being detected by the vehicle 502. Similarly, the sensor of the infrastructure device 504 detects a first object within the bounding box 604A, a second object within the bounding box 604B, and a third object within the bounding box 604C. The object tracker 514 determines, using the position and shaped based object association that the objects are separate objects, respectively track object id 1, track object id 2, and track object id 3, being detected by the sensor of the infrastructure device 504.

A Hungarian algorithm may be used to associate N tracked objects to M perceived (sensed) objects to sensor using an IoU score. Object creation and deletion can be handled by the individual sensor object trackers (in this example, the first object tracker 512 and the second object tracker 514).

Referring now to FIG. 6B, in addition to using the IoU score in this example, the position and shape based object association may further use object states x, y, θ, s, Ar, L of an target as defined by its bounding box 610 to determine a motion model for use in the object association, e.g., a motion model for predicting the next position/state of the target at Δt, where a target is a possible object. For example, the motion model for the target of FIG. 6B over time t may be represented as follows.

Δx=sΔt cos θ

Δy=sΔt sin θ

Δθ=Δtv_{θ}

In the above, x and y represent the horizontal and vertical pixel location of the center of the target, and s and Ar represent the scale (area) and the aspect ratio of the bounding box 610, respectively. The variable L represents the length of the bounding box 610, and the angle θ represents the direction of movement relative to a constant x- and y-axis. The velocity components ve may be solved using, for example, a Kalman filter or a linear velocity model.

The object association can include using data from one or more sensors to determine the class of a detected object. Non-limiting examples of classes include “car,” “sports car,” “sedan,” “large truck,” “pedestrian,” and “bicycle.” In another example, a classification can be assigned based on the motion, over time, of LiDAR data, e.g., a LiDAR point cloud. It is noted that different sensor data may provide different object classifications. For example, a first classification of “bicycle” may be determined based on the LiDAR data whereas a second classification of “jogger” may be determined based on camera data. Accordingly, the classification of an object may be determined probabilistically (e.g., which of the first or second classifications is more likely). As the classification is probabilistic, the classification of an object can change over time.

In the example of FIG. 6A, each of the vehicle 502 and the infrastructure device 504 has only one sensor. However, the vehicle 502 (and optionally the infrastructure device 504) can have more than one sensor. As shown in FIG. 6C, in addition to LiDAR that senses objects 620A and 620B, a vehicle-mounted camera may sense objects 630A and 630B. FIG. 6C illustrates object association in image space re-projection. In brief, ray-trace association directs rays from the sensor (from the vehicle 502 in this example) through sensed objects. For example, a first ray projects from the vehicle 502 through the objects 620A and 630A, a second ray projects from the vehicle 502 through the object 620B, and a third ray projects from the vehicle 502 through the object 630B. Where, as here, there are multiple sensors at a common source, the ray-trace association may be used to fuse detected objects. For example, the object 620A detected by LiDAR of the vehicle 502 may be reprojected into image space to provide a reliable pose (e.g., for determination of a motion model) and the object 630A detected by the camera of the vehicle 502 may be used to provide a reliable classification for a single object 640. That is, the single object 640 is a fused combination of the separately detected objects 620A and 630A. In this way, instead of determining the path/movement/classification of an object using the position and shaped based object association using single sensors, different sensors from the same source (e.g., the vehicle 502 or the infrastructure sensor 504) may be fused for the object association.

While position and shape based object association can result in a (relatively) fast match with low computation, performance generally degrades with sensor miscalibration or a pose error that is considered relatively large. Moreover, the technique can be error prone in a cluttered environment. Accordingly, the present disclosure incorporates a track based object association. A track based object association associates object detections based on track similarity. While track based object detection requires object motion, which can result in a delayed match, the technique involves relatively low levels of computation. Further, the match accuracy improves as objects move.

Referring back to FIG. 6A, object association is performed on a per sensor basis, which results in one or more tracked objects per sensor. In some implementations, as described with regards to FIG. 6C, object association may be performed on a per source basis where sensed objects may be detected by more than one sensor of a source, such as the vehicle 502 or the infrastructure device 504. In either case, objects detected by sensors from different sources are not combined (fused) into a single tracked object, if appropriate. The track based object detection addresses this issue.

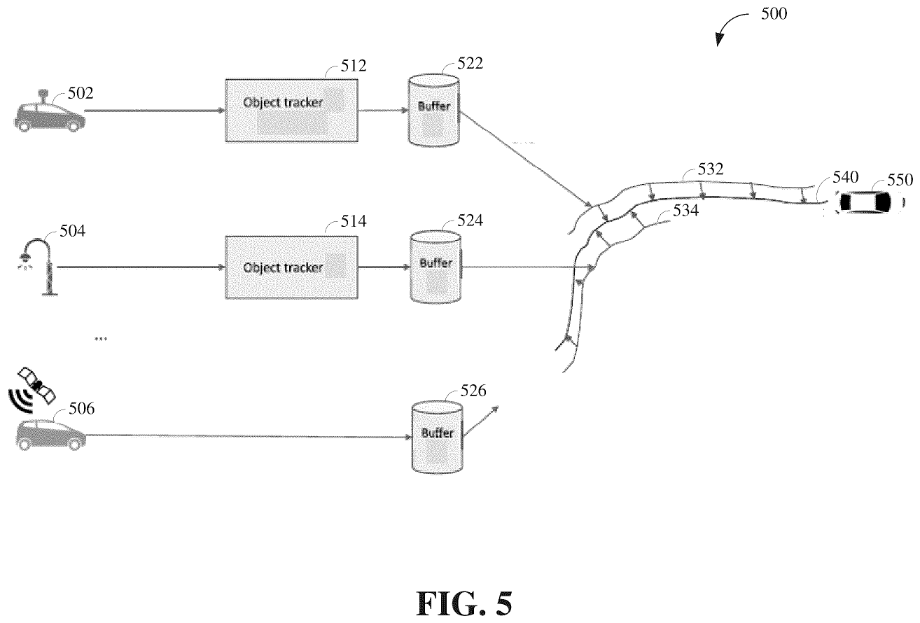

First, and referring to FIG. 5, the object tracker 512 provides position and optionally other information such as class, pose, etc., for each of one or more tracked objects, e.g., objects detected by sensor(s) of the vehicle 502, that have a stable id to a buffer 522. Similarly, the object tracker 514 similarly provides position and optionally other information such as class, pose, etc., for each of one or more tracked objects, e.g., objects detected by sensor(s) of the infrastructure device 504, that have a stable id to a buffer 524. A tracked object may be said to have a stable id when the object tracker 512 or the object tracker 514 determines that a sensed object over time is the same object for several cycles. Because the connected vehicle 506 is only tracking itself, that is, in this example the connected vehicle 506 is itself a tracked object, the sensed GPS data is provided to a buffer 526 with a single id.

Thereafter, synchronously sampled tracks with stable ids are provided as input to an Expectation-Maximization (EM) algorithm that matches tracks from a single sensor to a tracked object track. Broadly, the EM algorithm includes an E-step that matches M tracks to N tracked object tracks, and an M-step that computes an optimal sensor calibration. For example, the buffer 522 provides a synchronously sampled track 532 for an object to an EM algorithm, and the buffer 524 provides a synchronously sampled track 534 for an object to the EM algorithm. The EM algorithm matches the respective tracks 532, 534 from single sensors to a tracked object track 540 for the tracked object 550, using, e.g., normalized correlation.

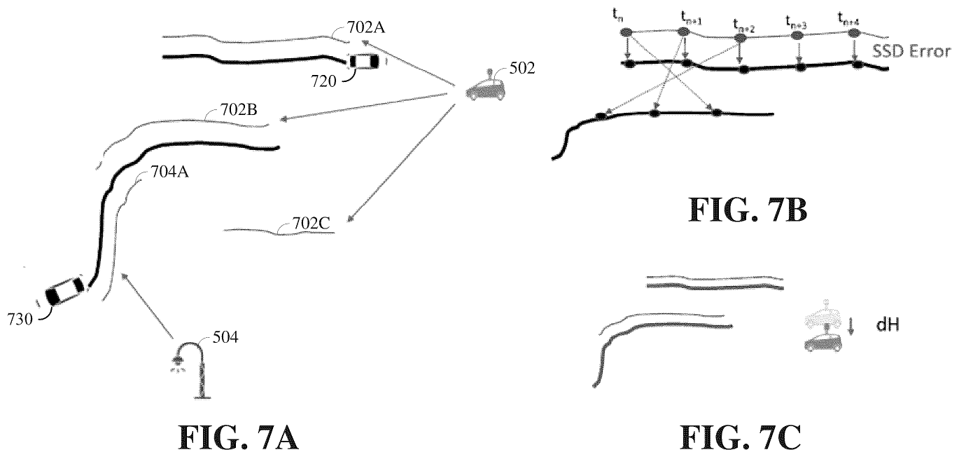

More specifically, and referring to FIGS. 7A-7C, further details of the EM algorithm according to FIG. 5 are shown. As in the previous examples, sensor data can be provided by a vehicle 502, an infrastructure device 504, etc. In this example the vehicle 502 represents a first sensor and the infrastructure device 504 represents a second sensor. As mentioned, the sensors provide tracks with stable ids for track to tracked object association and fusion. Each of a first track 702A, a second track 702B, and a third track 702C identified by the first sensor of the vehicle 502 and a first track 704A identified by the second sensor of the infrastructure device 504 are shown. Through the E-step calculations (e.g., normalized correlations) that match M tracks from a single sensor to N tracked object tracks, the first track 702A of the first sensor is matched to a first tracked object 720, the second track 702B of the first sensor is matched to a second tracked object 730, and the third track 702C of the first sensor is matched to a new tracked object. Similarly, the first track 704A of the second sensor is matched to the second tracked object 730.

Thereafter, the M-step computes a (e.g., optimal) sensor calibration. As shown in FIGS. 7B and 7C, for example, a Hungarian algorithm matches M tracks to N tracked object tracks to minimize total error, such as a sum of squared differences (SSD) between respective tracks at tₙ, tₙ₊₁, tₙ₊₂, tₙ₊₃, tₙ₊₄, etc., and a respective tracked object track. A rigid body transform dH is the calibration for the first sensor that minimizes the (e.g., SSD) error.

Thereafter, the separate tracked object tracks from the separate sensors are combined using object fusion techniques. Any technique for object fusion may be use, such as the examples described above with regards to FIG. 4B. Each moving object is then tracked, and its future positions are predicted for use in vehicle control as described previously.

While the architecture 500 is functional, it suffers from some deficiencies. For example, the architecture 500 can fail to associate new tracks to existing tracks when the sensor offset is large and unknown. An automotive grade GPS is thus difficult to incorporate in the process. Further, latency (e.g., the signal delay) is determined by the worst case (e.g., slowest) sensor. That is, as mentioned above, a shared world model may be used for controlling one or more vehicles traversing a vehicle transportation network, whether located within a vehicle or at a remote computing location. Latency can cause a detected object to appear to be at a location when in fact the object has moved to a different location. This inaccuracy in the shared world model can result in an inappropriate response by a vehicle. Receiving and resolving sensor data in a timely fashion are important for making safety-critical maneuvers, for example activating automatic emergency braking (AEB) or swerving.

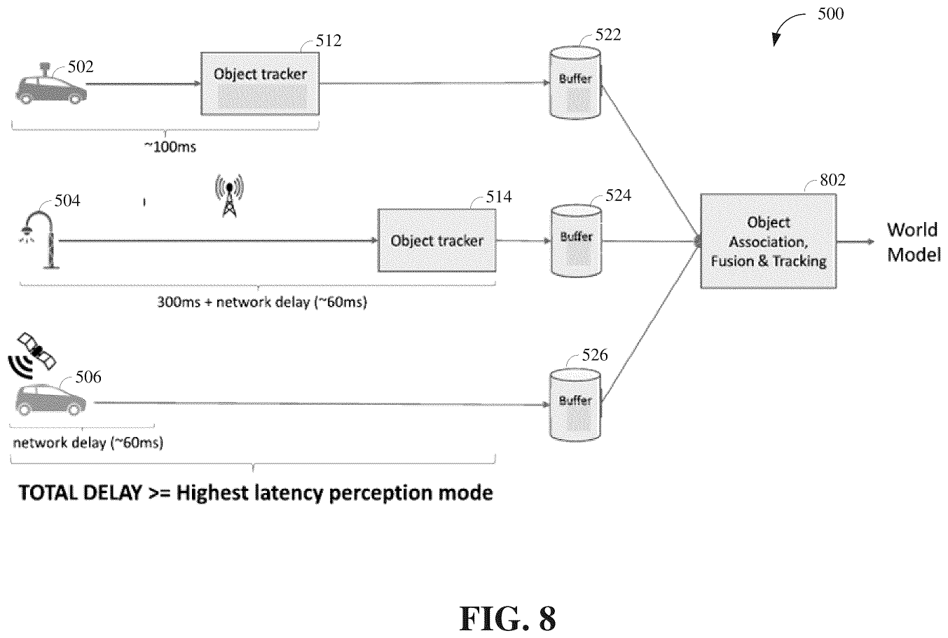

Latency is explained further with reference to FIG. 8. FIG. 8 is a diagram of heterogenous latency and buffering of the track based moving object association according to FIG. 5.

FIG. 8 shows the three heterogenous sensors as described previously. Namely, the vehicle 502 includes LiDAR as an example of a sensor, the infrastructure device 504 includes a smart camera as a sensor, and the connected vehicle 506 includes a GPS sensor. Latency may be considered as the amount of time from a sensed input to useable result a buffer, such as the respective buffers 522, 524, and 526, for synchronous sampling discussed previously. The latency of the LiDAR sensor is approximately 100 ms. The latency of the camera sensor is approximately 300 ms plus any network delay. For example, where the network includes a cellular network, such as the MEC 310 described above, a network delay can add 60 ms to the latency. For a GPS sensor, the latency results from the network delay, in this example 60 ms.

The object data (e.g., tracks for objects with a stable id) are synchronously output from the buffers 522, 524, 526 for object association, fusion, and tracking operations at component(s) 802 according to the techniques described above as part of or as input to the shared world model. The updates are made in temporal order. As can be seen from FIG. 8, the total delay is greater than or equal to the highest latency perception mode, here the smart camera of the infrastructure device 504. In this example, the total delay is at least as high as 360 ms.

Accordingly, latency can cause the perceived location of an object to be different from its actual location. Moreover, the architecture 500 takes many cycles to produce actionable tracked object track data. For example, while tracked based object association requires relatively low computation compared to other techniques, it requires object motion, which can delay matches. A modification of the tracked based object association of FIG. 5 is next described that addresses these issues.

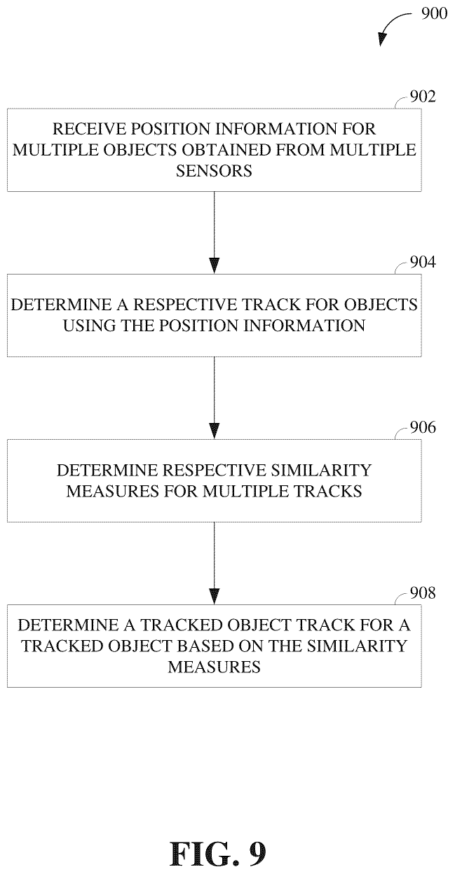

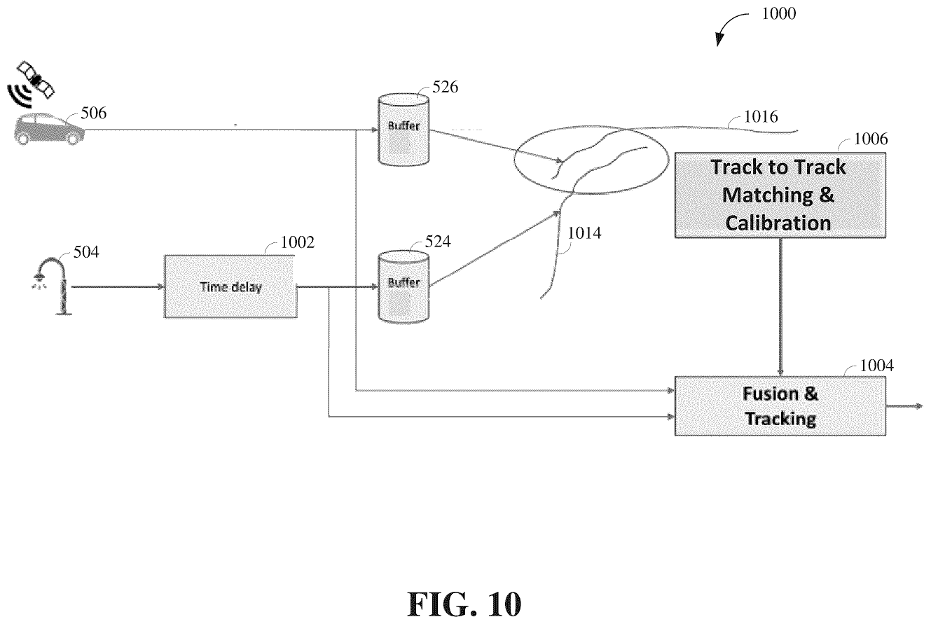

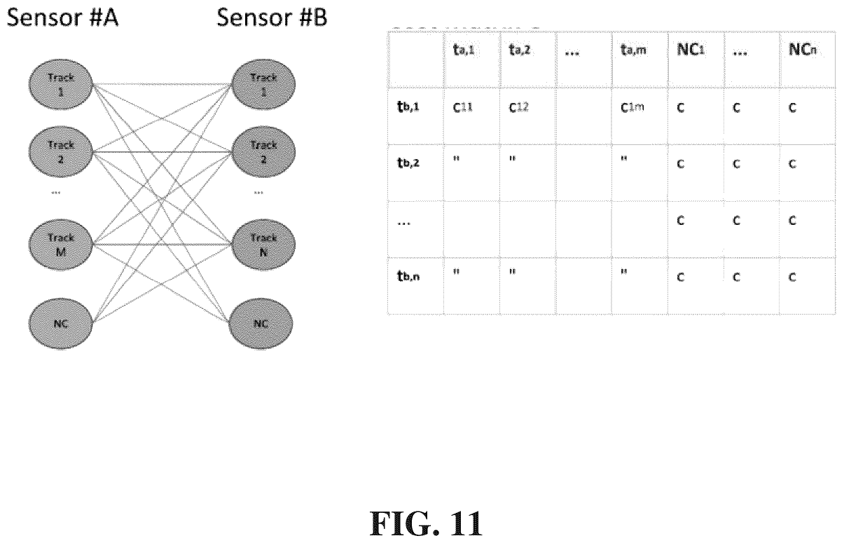

FIG. 9 is flowchart diagram of a method, technique, or process 900 of a track based moving object association according to the teachings herein. The process 900 includes operations 902 through 908, which are initially described below with reference to FIG. 10 and with later reference to FIG. 11.

The process 900 can be implemented in whole or in part by the system 300 of FIG. 3, in particular by the MEC 310 and/or the CAV 320. The process 900 can be stored in a memory (such as the memory 122 of FIG. 1) as instructions that can be executed by a processor (such as the processor 120 of FIG. 1) of a host vehicle (such as the vehicle 100 of FIG. 1). The process 900 may be implemented in whole or in part by a remote support control system, such as at the server computing device 234 or the MEC 310.

The process 900 receives position information for multiple objects obtained from multiple sensors at operation 902. The position information be accompanied by time stamps, sensor ID, object characteristics, etc. The multiple objects are detected within a portion of a vehicle transportation network, such as that described with regards to FIG. 2. The multiple objects can include stationary objects and moving objects such as connected vehicles, AVs, and other road users described previous.

In the architecture 500, the position information from other than a sensor of a connected road user, such as the connected vehicle 506, is provided to respective object trackers, such as object trackers 512, 514. Thereby, tracks for objects with a stable ID from sensors are sent to buffers, such as the buffers 522, 524, for synchronous sampling. This architecture 500 is referred to above as a track to tracked object association and fusion architecture 500. This contrasts with FIG. 10, which is a diagram of a second example of track based moving object association according to the teachings herein. FIG. 10 is an example of a decoupled track to track association and fusion architecture 1000.

In the architecture 1000, the infrastructure device 504 includes a smart camera as a sensor, and the connected vehicle 506 includes a GPS sensor. The latency in the receipt of position information at operation 902 from the infrastructure device 504 is represented as a time delay 1002. Note that the latency is minimized by this arrangement in that the object information (e.g., the position information) is transmitted directly to buffers, here the buffers 524 and 526. As shown, the position information is also received at a fusion and tracking module 1004, discussed later, at operation 902.

Returning to FIG. 9, the process 900 determines a respective track for objects using the position information at operation 904. Like those in the architecture 500, the buffers 524, 526 are synchronously sampled to produce data for determining the respective tracks. Determining the respective track at operation 904 may include techniques like those discussed previously for determining tracks. Initially, for example, the object association module, hereinafter referred to as the track to track matching and calibration module 1006 may use extended Kalman filtering with position and shape based object association as described with regards to FIGS. 6A through 6C to identify respective tracks. Then, track to track matching and calibration are performed using respective tracks, such as respective tracks 1014, 1016, using a modified technique from that described with regards to FIGS. 7B and 7C.

More specifically, and as described with reference to FIG. 11, the process 900 determines respective similarity measures for multiple tracks at operation 906 and determines a tracked object track for a tracked object based on the similarity measures at operation 908. The EM algorithm of track to track matching and calibration module 1006 differs from that of the EM algorithm of the architecture 500 described above with regards to FIGS. 7A-7C in that the EM algorithm previously described performs the E-step calculations (e.g., normalized correlations) to match multiple tracks from a single sensor to multiple tracked object tracks, while the E-step calculations of the track to track matching and calibration module 1006 match multiple tracks from multiple sensors to each other. The multiple tracks comprise at least a first track determined using the position information of a first sensor of the multiple sensors and a second track determined using the position information of a second sensor of the multiple sensors

Respective similarity measures may be determined at operation 906 for pairs of sensors. That is, the multiple sensors may comprise pairs of sensors, and the similarity measures may be determined on a track to track basis. The example of FIG. 11 shows a first sensor referred to as Sensor #A and a second sensor referred to as Sensor #B. Location information from the first sensor identifies M tracks while location information from the second sensor identifies N tracks. M and N may be equal or may have different positive integer values. For example, M may be greater than N. While FIG. 11 shows that each of M and N are greater than one—that is, each sensor has detected more than one track—this is not required. M, N, or both may be equal to one. As also seen in FIG. 11, the possibility of no matches is indicated by “NC”.

The cost matrix of pairwise matches between tracks from the two sensors includes a cost (e.g., a multiplier) for matches between respective tracks at time points along the analyzed time period. An example of the cost matrix as shown in FIG. 11 includes, along the horizontal, tracks t_{a,1}, t_{a,2}, . . . t_{a,m} corresponding respective Tracks 1, 2, . . . , M of Sensor #A and, along the vertical, tracks t_{b,1}, t_{a,2}, . . . t_{a,n} corresponding to Tracks 1, 2, . . . , N of Sensor #B. Determining similarity measures at operation 906 may include determining a total error, such as a SSD or other difference values, between locations indicated by the two sensors at respective time points similar to the technique described with respect to FIG. 7B. The similarity measures may be determined between respective pairs of tracks. The similarity measures may be modified by the costs of the cost matrix to compute the optimal matches (minimizing a total cost) using the Hungarian algorithm. For example, for the similarity measure of Track 1 of Sensor #A and Track 2 of Sensor #B, a cost (e.g., multiplier) of C11 is used. Similarly, a cost (e.g., multiplier) of C1m is used for the similarity measure of Track M of Sensor #A and Track 2 of Sensor #B. The values for the cost matrix may be established a priori and may be applied depending upon one or more characteristics of the match. For example, the cost matrix values can be determined to penalize matches between tracks with a short overlap duration (e.g., an overlap duration below a defined duration) or a short distance traveled (e.g., a distance traveled below a defined distance), or both.

As can also be seen with reference to the cost matrix, a predefined default cost C may be used in computing the optimal matches. The predefined default cost C is a value used when a track of a second has no match with a track of another sensor. For example, if Track N of Sensor #B has no match to a track of Sensor #A, the cost is C in the algorithm.

The minimum total cost indicates the optimal matches between a respective track of the first sensor and a track of the second sensor or no track of the second sensor. That is, the similarity measures determined at operation 906 are used to determine a tracked object track for a tracked object. In an example, multiple tracked object tracks for respective objects may be determined as the optimal matches.

This example described with regards to FIG. 11 uses one pair of sensors. If there are more sensors, each sensor pair is separately analyzed, and the minimum total cost of the respective matches is determined. For example, determining respective similarity measures for multiple tracks at operation 906 includes determining respective similarity measures for pairs of tracks. In addition to the first pair of the pairs of tracks including the first track and the second track, a second pair of the pairs of tracks includes the first track and a third track determined using a third sensor of the multiple sensors, and a third pair of the pairs of tracks includes the second track and the third track.

One or more of the sensors may be calibrated like the calibration described with regards to FIG. 7C. For example, a rigid body transform dH may be determined that minimizes the error (e.g., the SSD error) between the first sensor and any tracked object track with which it identifies.

After the track to track matching at the track to track matching and calibration module 1006 described above, the object information from respective sensors at respective points of the different tracked object tracks are combined using object fusion techniques by the fusing and tracking module 1004. Any technique for object fusion may be used, such as the examples described above with regards to FIG. 4B. Each moving object is then tracked, and its future positions are predicted for use in vehicle control as described previously.

As mentioned previously with regards to FIG. 10, the fusion and tracking module 1004 receives the position information (and other object data) asynchronously. The track association and sensor pair calibration from the track to track matching and calibration module 1006 is delayed as compared to the asynchronous data due, in part, to the synchronous sampling from buffers, such as the buffers 524, 526. As a result, the fusion and tracking module 1004 outputs un-matched objects (e.g., from the asynchronous inputs) as separate objects until they are matched (i.e., are identified with a track object track). This desirably results in a world model without delays in receiving object information for vehicle control.

The teachings herein describe an approach to object association and fusion that is robust to clutter, heterogenous and variable latencies, and communications constraints, all of which are present to a large degree when dealing with GPS, connected vehicular sensors, and connected road infrastructure sensors.

Herein, the terminology “passenger”, “driver”, or “operator” may be used interchangeably. As used herein, the terminology “processor”, “computer”, or “computing device” includes any unit, or combination of units, capable of performing any method, or any portion or portions thereof, disclosed herein.

As used herein, the terminology “instructions” may include directions or expressions for performing any method, or any portion or portions thereof, disclosed herein, and may be realized in hardware, software, or any combination thereof. For example, instructions may be implemented as information, such as a computer program, stored in memory that may be executed by a processor to perform any of the respective methods, algorithms, aspects, or combinations thereof, as described herein. In some implementations, instructions, or a portion thereof, may be implemented as a special-purpose processor or circuitry that may include specialized hardware for carrying out any of the methods, algorithms, aspects, or combinations thereof, as described herein. In some implementations, portions of the instructions may be distributed across multiple processors on a single device, or on multiple devices, which may communicate directly or across a network, such as a local area network, a wide area network, the Internet, or a combination thereof.

As used herein, the terminology “example,” “embodiment,” “implementation,” “aspect,” “feature,” or “element” indicate serving as an example, instance, or illustration. Unless expressly indicated otherwise, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “determine” and “identify,” or any variations thereof, includes selecting, ascertaining, computing, looking up, receiving, determining, establishing, obtaining, or otherwise identifying or determining in any manner whatsoever using one or more of the devices shown and described herein.

As used herein, the terminology “or” is intended to mean an inclusive “or” rather than an exclusive “or.” That is, unless specified otherwise or clearly indicated otherwise by the context, “X includes A or B” is intended to indicate any of the natural inclusive permutations thereof. If X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from the context to be directed to a singular form.

Further, for simplicity of explanation, although the figures and descriptions herein may include sequences or series of operations or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and/or elements.

While the disclosed technology has been described in connection with certain embodiments, it is to be understood that the disclosed technology is not to be limited to the disclosed embodiments but, on the contrary, is intended to cover various modifications and equivalent arrangements included within the scope of the appended claims, which scope is to be accorded the broadest interpretation as is permitted under the law so as to encompass all such modifications and equivalent arrangements.

What is claimed is:

1. An apparatus, comprising:
a processor configured to:
receive position information for multiple objects within a portion of a vehicle transportation network, the position information obtained from multiple sensors within the portion of the vehicle transportation network;
determine, using the position information of a respective sensors of the multiple sensors, a respective track for objects of the multiple objects;
determine respective similarity measures for multiple tracks, wherein the multiple tracks comprise at least a first track determined using the position information of a first sensor of the multiple sensors and a second track determined using the position information of a second sensor of the multiple sensors; and
determine, based on the similarity measures, a tracked object track for a tracked object of the multiple objects.

2. The apparatus of claim 1, wherein:
to determine the respective track for objects of the multiple objects comprises to determine M tracks for the first sensor and to determine N tracks for the second sensor,
to determine respective similarity measures for multiple tracks comprises to compare the M tracks to N tracks by minimizing difference values between points along the M tracks and the N tracks, and
M and N are positive integers greater than or equal to one.

3. The apparatus of claim 2, wherein to match the M tracks to N tracks comprises performing a Hungarian algorithm with the M tracks and the N tracks as input, and minimizing the difference values comprises minimizing a sum of squared differences.

4. The apparatus of claim 3, wherein the Hungarian algorithm penalizes matches between the multiple tracks having at least one of an overlap duration below a defined duration or distance traveled below a defined distance.

5. The apparatus of claim 2, wherein M is greater than N.

6. The apparatus of claim 2, wherein the processor is configured to calibrate a sensor of the multiple sensors by determining a rigid body transform that minimizes difference values between a track of the M tracks and a corresponding tracked object track.

7. The apparatus of claim 1, wherein the multiple sensors comprise at least two of a global positioning system signal of an object of the multiple objects, an infrastructure sensor mounted within the portion of the vehicle transportation network, or an optical, an infrared, or a light detection and ranging (lidar) sensor of an object of the multiple objects.

8. The apparatus of claim 1, wherein the processor is configured to output the position information to an object fusion and tracking module that outputs any un-matched objects of the multiple objects to a world model as separate objects, wherein an un-matched object is an object associated with only one track.

9. The apparatus of claim 8, wherein the processor is configured to add a time delay to the position information from an infrastructure sensor of the multiple sensors before determining the respective track and before outputting the position information.

10. The apparatus of claim 1, wherein to determine, based on the similarity measures, the tracked object track for the tracked object of the multiple objects comprises to fuse position information of a pair of tracks forming the tracked object track.

11. A method, comprising:
receiving position information for multiple objects within a portion of a vehicle transportation network, the position information obtained from multiple sensors within the portion of the vehicle transportation network;
determining, using the position information of a respective sensors of the multiple sensors, a respective track for objects of the multiple objects;
determining respective similarity measures for multiple tracks, wherein the multiple tracks comprise at least a first track determined using the position information of a first sensor of the multiple sensors and a second track determined using the position information of a second sensor of the multiple sensors; and
determining, based on the similarity measures, a tracked object track for a tracked object of the multiple objects.

12. The method of claim 11, wherein:
determining the respective track for objects of the multiple objects comprises determining M tracks for the first sensor and determining N tracks for the second sensor,
determining respective similarity measures for the multiple tracks comprises comparing the M tracks to N tracks by minimizing difference values between points along the M tracks and the N tracks, and
M and N are positive integers greater than or equal to one.

13. The method of claim 12, wherein matching the M tracks to N tracks comprises performing a Hungarian algorithm with the M tracks and the N tracks as input, and minimizing the difference values comprises minimizing a sum of squared differences.

14. The method of claim 13, wherein the Hungarian algorithm penalizes matches between a pair of tracks having at least one of an overlap duration below a defined duration or distance traveled below a defined distance.

15. The method of claim 12, comprising:
calibrating a sensor of the multiple sensors by determining a rigid body transform that minimizes difference values between a track of the M tracks from the sensor and a corresponding tracked object track.

16. The method of claim 11, wherein determining respective similarity measures for multiple tracks, wherein the multiple tracks comprise determining respective similarity measures for pairs of tracks, a first pair of the pairs of tracks comprises the first track and the second track, a second pair of the pairs of tracks comprises the first track and a third track determined using a third sensor of the multiple sensors, and a third pair of the pairs of tracks comprises the second track and the third track.

17. The method of claim 11, wherein the multiple sensors comprise at least two of a global positioning system signal of an object of the multiple objects, an infrastructure sensor mounted within the portion of the vehicle transportation network, or an optical, an infrared, or a light detection and ranging (lidar) sensor of an object of the multiple objects.

18. The method of claim 11, comprising:
outputting the position information to an object fusion and tracking module that outputs any un-matched objects of the multiple objects to a world model as separate objects, wherein an un-matched object is an object associated with only one track.

19. The method of claim 18, wherein the first sensor and the second sensor are heterogeneous, the method comprising:
synchronously outputting the position information to an object association module for determining the similarity measures for multiple tracks, wherein outputting the position information to the object fusion and tracking module comprises outputting the position information asynchronously.

20. A computer-readable storage medium storing instructions, the instructions causing a processor to perform a method comprising:
receiving position information for multiple objects within a portion of a vehicle transportation network, the position information obtained from multiple sensors within the portion of the vehicle transportation network;
determining, using the position information of a respective sensors of the multiple sensors, a respective track for objects of the multiple objects;
determining respective similarity measures for pairs of tracks, wherein each track of a pair of tracks is associated with a different sensor of the multiple sensors;
determining, based on the similarity measures, a tracked object track for a tracked object of the multiple objects;
outputting the position information to an object fusion and tracking module that outputs any un-matched objects of the multiple objects to a world module as separate objects, wherein an un-matched object is an object associated with only one track; and
outputting tracks for those of the multiple sensors forming the tracked object track to the object fusion and tracking module to output matched objects of the multiple objects to the world model as a single object.
